(19) United States
(12) Patent Application Publication
(10) Pub. No.: US 2009/0256111 A1
(43) Pub. Date: Oct. 15, 2009

(54) DIALKYLBORANE AMINE COMPLEXES

(75) Inventor: Elizabeth Burkhardt, Bridgeville, PA (US)

Correspondence Address: CONNOLLY BOVE LODGE & HUTZ, LLP, P O BOX 2207, WILMINGTON, DE, 19899, US

(73) Assignee: BASF SE Patents, Trademarks and Licenses, Ludwigshafen (DE)

(21) Appl. No.: 12/513,886

(22) PCT Filed: Nov. 5, 2007
(86) PCT No.: PCT/EP07/61859

§ 371 Date: May 7, 2009

Related U.S. Application Data
(60) Provisional application No. 60/865,100, filed on Nov. 9, 2006.

(51) Int. Cl. C07F 5/04; C09K 3/00

(52) U.S. Cl. 252/182.12; 546/13

(57) ABSTRACT

The present invention relates to new dialkylborane amine complexes, a process for the synthesis of new dialkylborane amine complexes, solutions comprising new dialkylborane amine complexes and a method of using new dialkylborane amine complexes for organic reactions.

### FIELD OF THE INVENTION

The present invention relates to new dialkylborane amine complexes, a process for the synthesis of new dialkylborane amine complexes, solutions comprising new dialkylborane amine complexes and a method of using new dialkylborane amine complexes for organic reactions.

### BACKGROUND OF THE INVENTION

Dialkylboranes (R₂BH) are valuable reagents for regioselective hydroboration reactions, since the boron atom adds exclusively to the less sterically hindered carbon atom of a carbon-carbon double bond. In addition, dialkylboranes with chiral alkyl substituents, like diisopinocampheylborane ((Ipc)₂BH), can be used effectively for the asymmetric reduction of ketones.

Application of dialkyboranes is, however, sometimes hampered by their poor solubility in nonpolar and polar solvents. In nonpolar solvents, dialkylborane compounds generally exist as the hydrogen bridged dimer. Unfortunately, even the use of coordinating solvents like tetrahydrofuran (THF) does not always increase the solubility of the dialkylboranes. For example, the solubility of 9-borabicyclo[3.3.1]nonane (9-BBN) is only 0.5 M in hexane or THF. Another undesirable property of dialkylboranes is the pyrophoric nature of the isolated solid, making the compounds difficult to handle on a large scale. It is therefore desirable to develop dialkylborane derivatives with improved solubility and reduced handling difficulties, that still exhibit a reasonable balanced reactivity.

Dialkylboranes with sterically hindered alkyl substituents are sometimes thermally unstable and tend to isomerize via sequential dehydroboration-hydroboration reactions, leading to compounds with the boron atom bound to a carbon atom in a less encumbered position. The coordination of an appropriately chosen Lewis base to bulky dialkylboranes may have a beneficial effect on the thermal stability of these compounds. Furthermore, it was observed in some cases that addition of a Lewis base to a dialkylborane leads to disproportionation giving mainly the trialkylborane and the monoalkylborane-Lewis base complex, which is undesirable as well.

Numerous dialkylborane complexes with amines are known in the literature. For example, Brown et al. described several dibutylborane amine complexes (n-butyl, isobutyl, s-butyl) with pyridine, that were neat liquids (Brown, H. C.; Gupta, S. K. J. Am. Chem. Soc. 1971, 93, 1817), and also ethylenediamine (EDA) complexes of dicyclohexylborane, (Ipc)₂BH and disiamylborane (Brown, H. C. Inorg, Chem. 1979, 18, 53). The EDA complexes contained two dialkylborane moieties such that each nitrogen atom was coordinated to another boron atom. The dicyclohexylborane-EDA complex was insoluble in diethylether but soluble in THF. The EDA adducts of disiamylborane and diisopinocampheylborane were prepared in ether and THF respectively but were not isolated. These compounds were monitored by Brown for 30 days at 0° C. and did not show detectible isomerization or redistribution.

Unfortunately, the pyridine and EDA complexes described above required addition of borontrifluoride to complex the pyridine or EDA before the dialkylborane could be used for hydroborations. The need to add a Lewis acid like borontrifluoride (BF₃) could lead to other undesired side reactions (such as ether cleavage) and generates excessive waste, e. g. as the EDA-BF₃ complex.

Brown et al. further prepared (Brown, H. C.; Kulkarni, S. U. Inorg. Chem. 1977, 16, 3090) and studied the hydroboration rates of 9-BBN amine complexes in THF with N-methylpiperidine, tetramethylethylendiamine, trimethylamine, pyridine and 2-picoline as amine (Brown, H. C.; Chandrasekharan, J. Gazzetta Chemica Italiana 1987, 117, 517; Wang, K. K.; Brown, H. C. J. Am. Chem. Soc. 1982, 104, 7148) It was found that, with the exception of the 9-BBN-trimethylamine complex, these 9-BBN amine complexes were more reactive towards 2-methyl-1-pentene at 25° C. than 9-BBN in THF. As expected, the stronger complex with trimethylamine dissociates slower leading to a slower hydroboration reaction. The experiments were conducted at a concentration of 0.3M in 9-BBN-amine complex and the compounds were not isolated. Brown did not describe the solubility of the 9-BBN amine compounds. Soderquist et al. explored the solubility of 9-BBN in various solvents but did not try amines as solvents (Soderquist, J. A.; Brown, H. C. J. Org. Chem. 1981, 46, 4599).

Brown and Wang (Brown, H. C.; Wang, K. K. J. Org. Chem. 1980, 45, 1748) found that 2-tert.-butylpyridine and triethylamine did not coordinate to 9-BBN, 2-ethylpyridine, 2-isopropyl-pyridine and diisopropylamine were only partially complexed and rapid exchange occurred with these amines in solution. 2-Picoline formed a stable complex with amine exchange but pyridine, n-propylamine, isopropylamine, diethylamine and quinoline formed stable non-exchanging complexes with 9-BBN.

Diethylaniline forms a commercially available complex with borane (BH₃) that is quite reactive compared to most other trialkylamine borane and pyridine borane complexes and does not require addition of borontrifluoride for enhanced reactivity. However, the steric bulk of diethylaniline prevents it from coordinating with 9-BBN or even diethylborane. Diethyltrimethylsilylamine also is too bulky to coordinate with 9-BBN. Similar complexation of amines to borinane was observed by Brown and Pai. (Brown, H. C.; Pai, G. G., J. Org. Chem. 1981, 46, 4713.)

Therefore, it is desirable to develop new dialkylborane amine complexes with improved solubility and reduced pyrophoricity to facilitate their easy application even on a large scale. At the same time the new dialkylborane amine complexes should have an adequate reactivity for hydroborations and reductions without the need to use Lewis acids for decomplexation.

### SUMMARY OF THE INVENTION

It was an object of the present invention to provide new dialkylborane amine complexes and solutions thereof. Another object of the present invention was the development of a process to synthesize these new dialkylborane amine complexes. Still another object of the present invention was the development of methods of using the new dialkylborane amine complexes.

Accordingly, new dialkylborane amine complexes of the formula (1) have been found,

(R¹)₂BH•amine (1),

wherein
R¹ is C₁—C₁₀ alkyl, C₃—C₁₀ cycloalkyl, C6—C₁₄ aryl, C₇—C₁₆ aralkyl, C₇—C₁₆ alkaryl, C₂—C₁₀ alkenyl, C₂—C₁₀ alkynyl, substituted C₁—C₁₀ alkyl, CH₂SiMe₃, isopinocampheyl, or the two R¹ groups together with the BH moiety connecting them are 9-borabicyclo[3.3.1]nonane, boracyclopentane, 3-methyl-1-boracyclopentane or 3,4-dimethyl-1-boracyclopentane, and
amine represents quinoline, quinoxaline or a substituted pyridine of the formula (2)

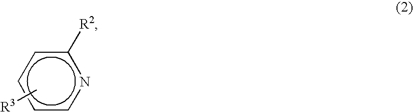

wherein
R² is C₁—C₁₀ alkyl, C₁—C₈ alkoxy, C₁—C₈-alkoxy-C₁—C₁₀ alkyl, or halogen and
R³ is hydrogen or a C₁—C₁₀ alkyl, C₁—C₈ alkoxy, C₁—C₈-alkoxy-C₁—C₁₀ alkyl group or halogen, which is not bound to the 6-position of the pyridine ring,

with the provision that R³ is not hydrogen and the amine in (1) is not quinoline when the dialkylborane is 9-borabicyclo[3.3.1]nonane.

Furthermore, a process has been found to synthesize the new dialkylborane amine complexes of the formula (1), comprising the step of reacting the dialkylborane (R¹)₂BH with the respective amine.

Another embodiment of the present invention are solutions comprising at least one of the new dialkylborane amine complexes of the formula (1) and at least one solvent.

The new dialkylborane amine complexes of the present invention can be employed for a large number of organic transformations. Examples are the reduction of functional groups and hydroboration reactions with alkenes, allenes and alkynes. Functional groups reduced by such dialkylborane amine complexes may for example include aldehyde, ketone, a,b-unsaturated ketone, oxime, imine and acid chloride groups.

### DETAILED DESCRIPTION OF THE INVENTION

The new dialkylborane amine complexes of the present invention have chemical structures according to the general formula (1),

(R¹)₂BH•amine (1),

wherein
R¹ is C₁—C₁₀ alkyl, C₃—C₁₀ cycloalkyl, C6—C₁₄ aryl, C₇—C₁₆ aralkyl, C₇—C₁₆ alkaryl, C₂—C₁₀ alkenyl, C₂—C₁₀ alkynyl, substituted C₁—C₁₀ alkyl, CH₂SiMe₃, isopinocampheyl, or the two R¹ groups together with the BH moiety connecting them are 9-borabicyclo[3.3.1]nonane, boracyclopentane, 3-methyl-1-boracyclopentane or 3,4-dimethyl-1-boracyclopentane, and
amine represents quinoline, quinoxaline or a substituted pyridine of the formula (2)

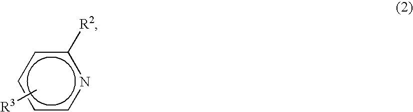

wherein
R² is C₁—C₁₀ alkyl, C₁—C₈ alkoxy, C₁—C₈-alkoxy-C₁—C₁₀ alkyl or halogen, and
R³ is hydrogen or a C₁—C₁₀ alkyl, C₁—C₈ alkoxy, C₁—C₈-alkoxy-C₁—C₁₀ alkyl group or halogen, which is not bound to the 6-position of the pyridine ring, with the provision that R³ is not hydrogen and the amine in (1) is not quinoline when the dialkylborane is 9-borabicyclo[3.3.1]nonane.

As used herein, the term “C₁—C₁₀ alkyl” denotes a branched or an unbranched saturated hydrocarbon group comprising between 1 and 10 carbon atoms. Examples are methyl, ethyl, propyl, isopropyl, n-butyl, isobutyl, sec-butyl, tert-butyl, amyl, isoamyl, sec-amyl, 1,2-dimethylpropyl, 1,1-dimethylpropyl, n-hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, n-heptyl, 5-methylhexyl, 1-methylhexyl, 2,2-dimethylpentyl, 3,3-dimethylpentyl, 4,4-dimethylpentyl, 1 ,2-dimethylpentyl, 1 ,3-dimethylpentyl, 1 ,4-dimethylpentyl, 1,2,3-trimethylbutyl, 1,1,2-trimethylbutyl, 1,1,3-trimethylbutyl, 2-ethylhexyl, n-octyl, 6-methylheptyl, 1-methylheptyl, 1,1,3,3-tetramethylbutyl, n-nonyl, 1-, 2-, 3-, 4-, 5-, 6- or 7-methyloctyl, 1-, 2-, 3-, 4- or 5-ethylheptyl, 1-, 2- or 3-propylhexyl, n-decyl, 1-, 2-, 3-, 4-, 5-, 6-, 7- and 8-methylnonyl, 1-, 2-, 3-, 4-, 5- or 6-ethyloctyl and 1-, 2-, 3- or 4-propylheptyl. Preferred are the alkyl groups methyl, ethyl, propyl, isopropyl, n-butyl, isobutyl, sec-butyl, tert-butyl, amyl, isoamyl, sec-amyl, 1,2-dimethylpropyl and 1,1-dimethylpropyl, most preferred are isoamyl groups.

The term “isoamyl” denotes a branched methylbutyl group, preferably 3-methyl-2-butyl.

The term “C₃—C₁₀ cycloalkyl” denotes a saturated hydrocarbon group comprising between 3 and 10 carbon atoms including a mono- or polycyclic structural moiety. Examples are cyclopropyl, cyclobutyl, cyclopentyl, cyclohexyl, methylcyclohexyl, dimethylcyclohexyl, cycloheptyl, cyclooctyl, norbornyl, isopinocampheyl, cyclononyl or cyclodecyl. Preferred are the cycloalkyl groups cyclopentyl, cyclohexyl, methylcyclohexyl and isopinocampheyl.

The term “isopinocampheyl” denotes all stereoisomers of a bicyclic hydrocarbon group obtainable via hydroboration of a-pinene.

The term “C₆—C₁₄ aryl” denotes an unsaturated hydrocarbon group comprising between 6 and 14 carbon atoms including at least one aromatic ring system like phenyl or naphthyl or any other aromatic ring system.

The term “C₇—C₁₆ aralkyl” denotes an aryl-substituted alkyl group comprising between 7 and 16 carbon atoms including for example a phenyl-, naphthyl- or alkyl-substituted phenyl- or alkyl-substituted naphthyl-group or any other aromatic ring system. Examples of aralkyl groups include benzyl, 1- or 2-phenylethyl, 1-, 2- or 3-phenylpropyl, mesityl and 2-, 3- or 4-methylbenzyl groups.

The term “C₇—C₁₆ alkaryl” denotes an alkyl-substituted aryl group comprising between 7 and 16 carbon atoms including for example a phenyl- or naphthyl- or alkyl-substituted phenyl- or alkyl-substituted naphthyl-group or any other aromatic ring system and an alkyl substituent as defined above. Examples for alkaryl groups are 2,- 3- or 4-methylphenyl, 2,- 3- or 4-ethylphenyl and 2,- 3-, 4-, 5-, 6-, 7- or 8-methyl-1-naphthyl groups.

The term “C₂—C₁₀ alkenyl” denotes a straight chain or branched unsaturated hydro-carbon group comprising between 2 and 10 carbon atoms including at least one carbon-carbon double bond. Examples are vinyl, allyl, 1-methylvinyl, butenyl, isobutenyl, 3-methyl-2-butenyl, 1-pentenyl, 1-hexenyl, 3-hexenyl, 4-methyl-3-pentenyl, 1-heptenyl, 3-heptenyl, 1-octenyl, 2,5-dimethylhex-4-en-3-yl, 1-nonenyl, 2-nonenyl, 3-nonenyl, 1-decenyl, 3-decenyl, 1,3-butadienyl, 1,4-pentadienyl, 1,3-hexadienyl, 1,4-hexadienyl. Preferred are the alkenyl groups vinyl, allyl, butenyl, isobutenyl, 1,3-butadienyl, 4-methyl-3-pentenyl and 2,5-dimethylhex-4-en-3-yl, most preferred are 4-methyl-3-pentenyl and 2,5-dimethylhex-4-en-3-yl.

The term “C₂—C₁₀ alkynyl” denotes a straight chain or branched unsaturated hydro-carbon group comprising between 2 and 10 carbon atoms including at least one carbon-carbon triple bond. Examples of alkynyl groups include ethynyl, 2-propynyl and 2- or 3-butynyl.

The term “substituted C₁—C₁₀ alkyl” denotes an alkyl group with at least one hydrogen atom replaced by a halide atom like fluorine, chlorine, bromine or iodine or by an C₁—C₈ alkoxy group.

The term “C₁—C₈ alkoxy” denotes a group derived from a branched or an unbranched aliphatic monoalcohol comprising between 1 and 8 carbon atoms. Examples are methoxy, ethoxy, propoxy, isopropoxy, n-butoxy, isobutoxy and n-pentoxy.

The term “C₁—C₈-alkoxy-C₁—C₁₀ alkyl” denotes a C₁—C₁₀ alkyl group as defined above, wherein one hydrogen atom is replaced by a C₁—C₈ alkoxy group as defined above. Examples are methoxymethyl (—CH₂OCH₃), ethoxymethyl (—CH₂OCH₂CH₃) and 2-methoxy-ethyl (—CH₂CH₂OCH₃).

In a preferred embodiment of the present invention the new dialkylborane amine complexes have chemical structures according to the general formula (1), wherein R¹ is cyclohexyl, cyclopentyl, methylcyclohexyl, isoamyl, isopinocampheyl, 4-methyl-3-pentenyl, 2,5-dimethylhex-4-en-3-yl or the two R¹ groups together with the BH moiety connecting them are 9-borabicyclo[3.3.1]nonane, boracyclopentane, 3-methyl-1-boracyclopentane or 3 ,4-d imethyl-1-boracyclopentane.

In another preferred embodiment of the present invention the new dialkylborane amine complexes have chemical structures according to the general formula (1), wherein the amine is quinoline, quinoxaline or a compound according to the formula (2), wherein R³ is hydrogen or C₁—C₄-alkyl.

Most preferred is an embodiment of the present invention where the new dialkylborane amine complexes have chemical structures according to the general formula (1), wherein the amine is quinoline, quinoxaline, 2-picoline, 2,3-lutidine, 2,4-lutidine, 2,5-lutidine or 5-ethyl-2-methylpyridine.

According to the invention, the substituted pyridine of the formula (2) can be, for example, 2-picoline, 2,3-lutidine, 2,4-lutidine, 2,5-lutidine, 5-ethyl-2-methylpyridine, 4-ethyl-2-methylpyridine, 3-ethyl-2-methylpyridine, 2,5-diethylpyridine, 5-propyl-2-methylpyridine, 4-propyl-2-methylpyridine, 5-isopropyl-2-methylpyridine, 5-t-butyl-2-methylpyridine, 5-n-hexyl-2-methylpyridine, 4-isobutyl-2-methylpyridine or 2,4-dipropylpyridine. Preferred pyridines of the formula (2) are 2-picoline, 2,3-lutidine, 2,4-lutidine, 2,5-lutidine and 5-ethyl-2-methylpyridine.

Another embodiment of the present invention is a process to synthesize the new dialkylborane amine complexes of the formula (1), comprising the step of reacting a dialkylborane with the respective amine. Preferably, the dialkylborane is brought into contact with the respective amine in the liquid phase in the presence of at least one solvent. Suitable solvents are at least partially miscible with the respective amine and able to dissolve the newly formed dialkylborane amine complexes, for example ethers like diethyl ether, tetrahydrofuran or 2-methyltetrahydrofuran, sulfides like dimethyl sulfide or 1,6-thioxane or hydrocarbons like pentane, hexane(s), heptane(s), cyclohexane, toluene or xylenes. Preferred solvents for the process of the present invention are tetrahydrofuran, 2-methyltetrahydrofuran, dimethyl sulfide, 1,6-thioxane, toluene, hexane(s), heptane(s) or cyclohexane, most preferred are tetrahydrofuran, 2-methyltetrahydrofuran, toluene, hexane(s), heptane(s) or cyclohexane.

The process of the present invention can generally be carried out at a temperature of from −40 to +70° C., preferably of from 0 to +35° C.

A preferred embodiment of the process of the present invention comprises the addition of an amine to a solution of a dialkylborane in tetrahydrofuran or 2-methyltetrahydrofuran.

Another preferred embodiment of the process of the present invention comprises the addition of an amine to a slurry of a dialkylborane in tetrahydrofuran, 2-methyltetrahydrofuran, dimethyl sulfide, 1,6-thioxane, toluene, hexane(s), heptane(s) or cyclohexane.

However, the amine may be present in excess compared to the dialkylborane and, therefore, may serve both as complexing agent for the dialkylborane and as solvent for the newly formed dialkylborane amine complex. Of course, one or more other solvents with lower complexing ability to dialkylboranes than the amine may also be present.

Another embodiment of the present invention is therefore a solution comprising at least one of the new dialkylborane amine complexes of the formula (1) and at least one solvent. Suitable solvents for the solutions of the present invention are those in which the dialkylborane amine complexes have a high solubility. Examples are ethers like diethyl ether, tetrahydrofuran or 2-methyltetrahydrofuran, sulfides like dimethyl sulfide or 1,6-thioxane and hydrocarbons like pentane, hexane(s), heptane(s), cyclohexane, toluene or xylenes. Preferred solvents for the solutions of the new dialkylborane amine complexes are tetrahydrofuran, 2-methyltetrahydrofuran, dimethyl sulfide, 1,6-thioxane, toluene, hexane(s), heptane(s) or cyclohexane, most preferred are tetrahydrofuran, 2-methyltetrahydrofuran, toluene, hexane(s), heptane(s) or cyclohexane.

The solutions of the present invention generally contain the new dialkylborane amine complexes of the formula (1) in concentrations between 0.05 and 5 mol/l, preferably between 0.5 and 5 mol/l, more preferably between 0.75 and 3 mol/l. The ability to prepare the solutions of the new dialkylborane amine complexes with these relatively high concentrations offers numerous economic and environmental advantages compared to the use of uncomplexed dialkylboranes.

The solutions of the present invention can either be directly employed for further reactions or the dialkylborane amine complexes can be isolated in pure form by evaporation of the solvent. The preferred method for removal of the solvent evaporation under reduced pressure to decrease the solvent boiling point.

The ¹¹B NMR spectra of the dialkylborane amine complexes of the formula (1) generally show a doublet with a chemical shift around 0 ppm and a coupling constant between ca. 80 and ca. 100 Hz, indicating monomeric dialkylborane amine complexes in solution. For example, 9-borabicyclo[3.3.1]nonane-5-ethyl-2-methylpyridine complex shows a ¹¹B NMR resonance at d=−1.3 ppm and a coupling constant ¹J(¹¹B¹H)=80 Hz. The coupling is not observed in concentrated solutions. The IR spectra show strong absorptions for B-H stretches in the region from 2300-2400 cm⁻¹.

The present invention further provides a method of using the new dialkylborane amine complexes of the formula (1) for organic reactions. The method comprises the step of contacting a dialkylborane amine complex and a substrate in a reaction vessel.

Organic reactions, for which the new dialkylborane amine complexes of the formula (1) can be employed according to the invention, include especially hydroboration reactions with alkenes, allenes or alkynes and reductions of functional groups such as aldehydes or ketones. Regioselective hydroboration reactions provide primarily one product. Monohydroboration of diene, enyne and diyne substrates occurs with high selectivity. In case of dialkylborane amine complexes with chiral substituents R¹, even asymmetric hydroboration reactions of alkenes and asymmetric reductions of ketones can be conducted.

Other methods of using the new dialkylborane amine complexes of the formula (1) include, but are not limited to, reductions of tertiary amides to alcohols or aldehydes, reactions with amino acids to achieve a higher solubility and protect the functional groups of the amino acids and 1,4-reductions of a,b-unsaturated ketones to give a boron enolate.

Owing to their balanced reactivity-stability-pattern, the new dialkylborane amine complexes of the present invention can be employed for organic reactions without the need to use Lewis acids for decomplexation. The high solubility of the new dialkylborane amine complexes coupled with good stability characteristics and the desirable reactivity are a tremendous advantage for the large scale utilization of these compounds. Especially the 2-picoline, 2,3-lutidine and 5-ethyl-2-methylpyridine complexes of dicyclohexylborane, diisopinocampheylborane and disiamylborane offer reactivity advantages over EDA or pyridine complexes, because borontrifluoride is not required to release the dialkylborane prior to hydroboration.

The following examples illustrate the present invention without limitation of the same.

### EXAMPLES

### Example 1: Preparation of 9-BBN-5-Ethyl-2-Methylpyridine Complex in THF

1.21 g (0.01 mol) of 5-Ethyl-2-methylpyridine was added to 20 ml of a 0.5M solution of 9-BBN (0.01 mol) in THF at 0-5° C. in 15 minutes. The ¹¹B NMR spectrum of the reaction mixture no longer showed the signal for 9-BBN at 27.8 ppm and a new signal appeared at d=−1.3 as a doublet (80 Hz), assigned to the 9-BBN-5-ethyl-2-methylpyridine complex. Part of the THF was removed under vacuum to leave a concentrated liquid, about 60 wt % 9-BBN-5-ethyl-2-methylpyridine complex. The ¹¹B NMR spectrum showed the product at d=−0.8 as a broad singlet (98% purity).

### Example 2: Preparation of 9-BBN-5-Ethyl-2-Methylpyridine Complex in Hexanes

49.7 g (0.41 mol) of 5-ethyl-2-methylpyridine was added to 820 ml of a 0.5M solution of 9-BBN (0.41 mol) in hexanes at 0-5° C. over 3.5 h. The ¹¹B NMR spectrum of the reaction mixture shows a new signal at d=−0.5 as a broad singlet, assigned to the 9-BBN-5-ethyl-2-methylpyridine complex (IR spectrum in hexanes: BH Str 2300-2400 cm⁻¹). The solvent was distilled off under vacuum from one half of the prepared hexanes solution to leave an amber pyrophoric liquid, 47.5 g (95% yield). The ¹¹B NMR spectrum showed a broad singlet at d=−1.6 (95% purity) assigned to the product.

Example 3: Preparation of Bis(2,5-Dimethylhex-4-En-3-yl)Borane-2-Picoline Complex in THF

2,5-Dimethyl-2,4-hexadiene (4.64 g, 40 mmol) was added to borane-tetrahydrofuran complex (20 ml, 1 M, 20 mmol BH₃) at 0C. After the hydroboration was complete 2-picoline (1.83 g, 20 mmol) was added to the solution of bis(2,5-dimethylhex-4-en-3-yl)borane. The bis(2,5-dimethylhex-4-en-3-yl)borane-2-picoline complex showed an ¹¹B NMR signal at d=−3.2 (broad singlet, 85% pure).

### Example 4: Preparation of Dicyclohexylborane-2-Picoline Complex in 2-Methyltetrahydrofuran

17.8 g (0.1 mol) of dicyclohexylborane was slurried in 50 ml of 2-methyltetrahydrofuran and 9.3 g (0.1 mol) of 2-picoline was added at 0-5° C. forming a 35 wt % solution of the dicyclohexylborane-2-picoline complex. The complex showed a signal in the ¹¹B NMR spectrum of the solution at d=1.0 (98.6% pure, coupling not observed in this concentrated sample). IR: 2368 cm⁻¹(B-H str); ¹³C NMR (C₆D₆): d=24.4 (2C), 28.4 (4C), 29.7 (4C), 32.3 (2C), 33.7, 121.6, 127.2, 137.8, 146.6, 158.4.

### Example 5: Preparation of Dicyclohexylborane-5-Ethyl-2-Methylpyridine Complex in THF

17.8 g (0.1 mol) of dicyclohexylborane was slurried in 50 ml of tetrahydrofuran and 12.1 g (0.1 mol) of 5-ethyl-2-methylpyridine was added at 0-5° C. forming a solution of the dicyclohexylborane-5-ethyl-2-methylpyridine complex. The complex showed a signal in the ¹¹B NMR spectrum of the solution at d=−0.1 (88% pure, coupling not observed in this concentrated sample).

In a similar way further dialkylborane amine complexes have been prepared, that are listed in Table 1:

TABLE 1
Dialkylborane amine complexes

| | | ¹¹B NMR: |
|---|---|---|
| | | δ (ppm), |
| Amine | R¹₂BH, R¹═ | ¹J(¹¹B¹H) Hz |
| 2-picoline | Cyclohexyl | 1.0 (br., s) |
| Quinoline | 9-BBN | −2.2, 86 |
| Quinoline | Cyclohexyl | 1.0 (br., s) |
| 2,3-lutidine | 9-BBN | 1.1, 83 |
| 2,3-lutidine | Cyclohexyl | 1.7 (br., s) |
| Quinoxaline | 9-BBN | −1.5 (br., s) |
| Quinoxaline | Cyclohexyl | 1.8 (br., s) |
| 5-ethyl-2- | 9-BBN | −0.8, (br., s) |
| methylpyridine | | −1.3, 80 in THF |
| 5-ethyl-2- | Cyclohexyl | −0.1, (br. s) |
| methylpyridine | | |
| 2-picoline | isopinocampheyl | 1.9, (br., s) |
| 2,3-lutidine | isopinocampheyl | 2.7, (br., s) |
| 2-picoline | 2,5-dimethylhex-4- | −3.2, (br., s) |
| | en-3-yl | |
| 2-picoline (compari- | 9-BBN | −1.0, 87 |
| son) | | |

### Examples 6 to 8: Reactivity of Dicyclohexylborane-Amine Complexes

2.71 g (10 mmol) of dicyclohexylborane-2-picoline complex was reacted with 1.12 g (10 mmol) 1-octene in 10 ml of THF at 22° C. No exotherm was observed. One hour after the addition, 62 % of the dicyclohexylborane-2-picoline had been consumed giving dicyclohexyloctylborane at 83 ppm (32 % yield) along with boronic esters at 52 ppm (27%) in the ¹¹B NMR spectrum. After 4 h the reaction was complete yielding 42% dicyclohexyloctylborane and boronic esters (46%).

The same reaction with dicyclohexylborane-2,3-lutidine complex required only about 1 hours to reach completeness (80 % yield of dicyclohexyloctylborane and 10% oxidized products).

1-pentyne (0.68 g, 10 mmol) was added to dicyclohexylborane-2-picoline (2.71 g, 10 mmol) in THF (10 ml) at 18° C. No exotherm was observed. Three and one half hours after the addition, 97% of the dicyclohexylborane-2-picoline had been consumed giving dicyclohexylpentylborane visible at 67 ppm (34 % yield) along with boronic and borinic esters at 51 and 25 ppm in the ¹¹B NMR spectrum.

1-10. (canceled)

11. A dialkylborane amine complex of the formula (1)
(R¹)₂BH•amine (1),
wherein
R¹ is C₁—C₁₀ alkyl, C₃—C₁₀ cycloalkyl, C₆—C₁₄ aryl, C₇—C₁₆ aralkyl, C₇—C₁₆ alkaryl, C₂—C₁₀ alkenyl, C₂—C₁₀ alkynyl, substituted C₁—C₁₀ alkyl, CH₂SiMe₃, isopinocampheyl, or the two R¹ groups together with the BH moiety connecting them are 9-borabicyclo[3.3.1]nonane, boracyclopentane, 3-methyl-1-boracyclopentane or 3,4-dimethyl-1-boracyclopentane, and
amine represents quinoline, quinoxaline or a substituted pyridine of the formula (2) 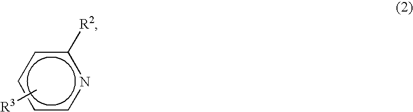
wherein
R² is methyl, ethyl, propyl, isopropyl, n-butyl, isobutyl, sec-butyl, amyl, isoamyl, sec-amyl, 1,2-dimethylpropyl, n-hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, n-heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 2-ethylhexyl, n-octyl, 6-methylheptyl, 1-methylheptyl, n-nonyl, 1-, 2-, 3-, 4-, 5-, 6- or 7-methyloctyl, 1-, 2-, 3-, 4- or 5-ethylheptyl, 1-, 2- or 3-propylhexyl, n-decyl, 1-, 2-, 3-, 4-, 5-, 6-, 7- or 8-methylnonyl, 1-, 2-, 3-, 4-, 5- or 6-ethyloctyl, 1-, 2-, 3- or 4-propylheptyl, C₁—C8 alkoxy or C₁—C₈-alkoxy-C₁—C₁₀ alkyl, and
R³ is hydrogen or a C₁—C₁₀ alkyl, C₁—C₈ alkoxy or C, —C₈-alkoxy-C₁—C₁₀ alkyl group, which is not bound to the 6-position of the pyridine ring,
with the provision that R³ is not hydrogen and the amine in (1) is not quinoline when the dialkylborane is 9-borabicyclo[3.3.1]nonane.

12. The dialkylborane amine complex according to claim 11, wherein R¹ is cyclohexyl, cyclopentyl, methylcyclohexyl, isoamyl, isopinocampheyl, 4-methyl-3-pentenyl, 2,5-dimethylhex-4-en-3-yl or the two R² groups together with the BH moiety connecting them are 9-borabicyclo[3.3.1]nonane, boracyclopentane, 3-methyl-1-boracyclopentane or 3,4-dimethyl-1-boracyclopentane.

13. The dialkylborane amine complex according to claim 11, wherein the amine is quinoline, quinoxaline, 2-picoline, 2,3-lutidine, 2,4-lutidine, 2,5-lutidine or 5-ethyl-2-methylpyridine.

14. The dialkylborane amine complex according to claim 12, wherein the amine is quinoline, quinoxaline, 2-picoline, 2,3-lutidine, 2,4-lutidine, 2,5-lutidine or 5-ethyl-2-methylpyridine.

15. A solution comprising at least one of the dialkylborane amine complexes according to claim 11 and at least one solvent.

16. A solution comprising at least one of the dialkylborane amine complexes according to claim 14 and at least one solvent.

17. The solution according to claim 15, wherein the solvent comprises the amine used to complex the dialkylborane in (1).

18. The solution according to claim 15, wherein the concentration of the dialkylborane amine complex is between 0.05 and 5 mol/l.

19. The solution according to claim 16, wherein the solvent comprises the amine used to complex the dialkylborane in (1).

20. The solution according to claim 19, wherein the concentration of the dialkylborane amine complex is between 0.05 and 5 mol/l.

21. A process to synthesize the new dialkylborane amine complexes according to claim 1, comprising the step of reacting a dialkylborane (R¹)₂BH with the amine.

22. A process according to claim 21, wherein a slurry of a dialkylborane in a solvent is reacted with the respective amine.

23. A organic reaction which comprises contacting the dialkylborane amine complex according to claim 11 and a substrate in a reaction vessel.

24. A organic reaction according to claim 23, wherein the organic reaction is a hydroboration reaction with alkenes, allenes or alkynes, a reduction of a functional group, a reaction with an amino acid or a 1,4-reduction of an α, β-unsaturated ketone.
